(19) United States
(12) Patent Application Publication
(10) Pub. No.: US 2024/0074572 A1
(43) Pub. Date: Mar. 7, 2024

(54) CLEANING KITS FOR WEARABLE DEVICES

(71) Applicant: Apple Inc., Cupertino, CA (US)

(72) Inventors: Seohui Jung, Santa Clara, CA (US); Jacob D. Dennis, Sunnyvale, CA (US); Michael B. Minerbi, San Francisco, CA (US); Arun D. Chawan, Berkeley, CA (US)

(73) Assignee: Apple Inc., Cupertino, CA (US)

(21) Appl. No.: 18/122,068

(22) Filed: Mar. 15, 2023

Related U.S. Application Data
(60) Provisional application No. 63/403,254, filed on Sep. 1, 2022.

(51) Int. Cl. A46B 15/00; A46B 9/02; A46B 11/00; B08B 1/00; B08B 3/08; C11D 1/00; C11D 11/00; C11D 17/00; C11D 17/04

(52) U.S. Cl. CPC A46B 15/0091; A46B 9/026; A46B 11/0027; A46B 11/0062; B08B 1/002; B08B 1/006; B08B 3/08; C11D 1/008; C11D 11/0047; C11D 17/003; C11D 17/049; A46B 2200/3073

(57) ABSTRACT

Cleaning kits for wearable devices that are simple to use, are less likely to damage wearable devices, and are effective at cleaning wearable devices. An example can include a cleaning cloth, a softening solution, a brush, and a soft gel. The cleaning cloth can be a lint-free cloth. The softening solution can be a protein emulsifier. The softening solution can be provided in an ampule or other sealed container. The brush can be formed of an elastomer, such as silicone, to reduce the chance of damage to a wearable device. The brush can have a snowball pattern to further reduce the chance of damage. The soft gel can be a hydrogel solution. The soft gel can be biodegradable and can be provided in a pouch having a tear notch.

### CROSS-REFERENCE TO RELATED APPLICATIONS

This application claims the benefit of U.S. application No. 63/403,254, filed Sep. 1, 2022, which is incorporated by reference.

### BACKGROUND

Wearable electronic devices, or more simply wearable devices, have become ubiquitous. Many of us find ourselves using multiple such devices on a regular basis. Wearable devices can include watches, audio devices, such as in-ear devices, on-ear headphones, over-the-ear headphones, eyewear, smart phones, augmented-reality devices, virtual-reality devices, and other devices.

These wearable devices can accumulate debris on their surfaces. Surfaces having a rough or non-smooth texture can accumulate debris at a faster pace. For example, wearable devices often have a perforated surface, such as a surface with a number of holes or micro-perforations. A surface can be formed of or include a mesh, where the mesh can be formed of interlocking strips or wires of wires or plastic.

Wearable devices can include a perforated or mesh surface for various reasons. For example, such a surface can be provided for ventilation to allow for the cooling of components below or behind the surface. Such a surface can be provided to allow audio signals to be provided or received, that is, a speaker or a microphone can be located behind a perforated or mesh surface. Pressure stabilization or equalization can be provided by a perforated or mesh surface. For example, a barometer housed in a device can be near a perforated or mesh surface.

Debris can gather in the perforations or mesh openings in such a surface. The debris can be dust and dirt from the environment, it can be organic matter from a user of the wearable device, or it can be other types of debris.

This debris is typically cleaned using less than ideal materials and methods. For example, sharp instruments are often used to remove organic matter from these surfaces. These can extend through a mesh or other surface and can reach and damage components below. Also, very high-tack substances are often used to remove debris. This material can pull a mesh surface away from other portions of the wearable device, thereby causing damage. Moreover, these techniques and materials are often not particularly effective at cleaning.

Thus, what is needed are kits, methods, and apparatus for cleaning wearable devices that are simple to use, are less likely to cause damage, and are effective.

### SUMMARY

Accordingly, embodiments of the present invention can provide kits, methods, and apparatus for cleaning wearable devices that are simple to use, are less likely to cause damage, and are effective. An illustrative embodiment of the present invention can provide cleaning kits for wearable devices that are simple to use. A cleaning kit can include components that can be effectively used in combination to clean a non-smooth surface of a wearable device. A kit can include a softening solution to at least partially dissolve debris. A brush to break up and sweep debris aside can be included. The kit can further include a soft gel to remove some residual debris. A cleaning cloth can be included for a final clean-up of the wearable device.

These and other embodiments of the present invention can provide cleaning kits that are less likely to damage a wearable device. A kit can include a softening solution that can be applied to a perforated or mesh surface without damaging underlying components of the wearable device. For example, the softening solution can be applied to a mesh over a speaker of a wearable device. The softening solution can be such that it does not damage the speaker. Specifically, the softening solution can have a high enough viscosity that it does not leach through the mesh surface or other protective layers that can be below or behind the mesh surface. That is, the softening solution can have a low capillary action such that it does not pass through the mesh surface or other protective layers, thereby helping to prevent damage to components in the wearable device. The softening solution can be removed by gently tapping or shaking the wearable device after time has been given for the softening solution to soften debris on the mesh surface.

A kit can include a brush that is formed of a soft, non-metallic material. The brush can be formed of an elastomer, such as silicone or other soft material. The brush material can have a Shore between 30 and 80. The brush material can have a Shore less than 80. The brush can have bristles arranged in a snowball pattern. That is, the brush can have bristles having a furthest reach in a pattern that approximates a sphere, or the bristles can have a furthest reach in a pattern that approximates an ellipsoid. This pattern can prevent the brush from being used to exert an excessive amount of force on a surface. The brush can further include a handle. The bristle snowball pattern can have a surface area that is relatively large, the individual bristles can be relatively thick, while the brush handle can be relatively short. This combination can allow a mesh surface to be cleaned with fewer strokes and less force, thereby providing further protection and helping to avoid puncturing or scratching the mesh surface. For example, providing a short handle for the brush can reduce a length of a lever-arm through which force can be applied, thereby reducing the resulting force on the mesh surface, while a large bristle pattern can distribute the resulting force across a larger area of the mesh surface. The bristles on the brush can be soft and thick such that debris is not pushed through a perforated or mesh surface into the wearable device. Where a mesh has a spacings such that the bristles can fit through the mesh surface, the snowball pattern can prevent excessive force from being applied to a structure in the wearable device below the perforations or mesh. During use, the brush can be swept laterally across the mesh surface. Pushing the brush into the mesh surface can be avoided to prevent debris from being ground into the mesh surface.

Various parameters of the brush, such as the size of the bristles, the size of the bristle pattern, the length and thickness of the handle, the stiffness of the bristles, the stiffness of the handle, and other parameters, can be varied to optimize cleaning of different wearable devices. The identity of a wearable device, the material that the surface to cleaned is made of, the presence or absence, and identity, of components below the surface to be cleaned, the size of the surface to be cleaned, and other factors, can be considered in determining these various parameters.

A kit can further include a low-adhesion soft gel. The soft gel can be soft enough to not provide excessive force when pushed against a mesh or other surface. The soft gel can have a low enough adhesion to not pull a mesh or other surface away from a body of a wearable device. The soft gel can adhere well to organic substances and debris. The soft gel can also be viscous enough to prevent a flow into the wearable device, which could otherwise cause damage. The soft gel can be a hydrogel solution. The soft gel can be water-based. The soft gel can be biodegradable. The soft gel can be applied to the area to be cleaned in a gentle vertical motion.

The viscosity of the soft gel can be varied to optimize the cleaning of different wearable devices. The identity of a wearable device, the material that the surface to cleaned is made of, the presence or absence, and identity, of components below the surface to be cleaned, the size of the surface to be cleaned, and other factors, can be considered in determining the viscosity of the soft gel. For some applications, viscosity can be increased, though the soft gel can retain a low-tack to hard surfaces to help to avoid damage. For other applications, viscosity can be decreased, thought the soft gel can retain enough viscosity, and a low enough capillary action, to prevent a flow into the wearable device.

A kit can include a cleaning cloth, where the cleaning cloth can be a lint-free cloth to avoid leaving fibers in a mesh surface where they can work their way into the wearable device. The lint-free cloth can be a microfiber or other cloth and can be formed of nylon, polyester, and polyamide, or a combination of these or other materials.

These and other embodiments of the present invention can provide cleaning kits that are effective at cleaning wearable devices. A kit can include a softening solution. The softening solution can include a protein emulsifier to break up organic matter, such as ear wax, from a perforated or mesh surface. The softening solution can be kept sterile before use to prevent degradation of effectiveness. For example, the softening solution can be provided for use in an ampule or other package. The softening solution can be packaged for a one-time use, the softening solution can be packaged in a resealable container, or the softening solution can be packaged in another type of container. A kit can include a soft brush that can be used to effectively sweep debris that has been softened by the softening solution off a perforated or mesh surface. A kit can include a soft gel that can adhere to remaining debris not swept away by the soft brush. The soft gel can be sealed in a pouch to help it retain its effectiveness. The pouch can have tear notches to allow for easy opening. The pouch can be formed of plastic, vinyl, foil, or other material or combination of materials. A kit can further include a cleaning cloth that can complete the cleaning of the wearable device in an effective manner by not leaving lint or fibers on a cleaned wearable device.

These and other embodiments of the present invention can provide other types of cleaning kits. An illustrative embodiment of the present invention can provide a cleaning kit in the form of a cleaning pen. The pen can have a soft brush at a first end of a barrel. The barrel can have an opening at a second end. Soft gel can be stored in the barrel and can be ejected from the second end for use in cleaning a wearable device. The second end can be covered by an end cap to prevent the soft gel from drying between uses.

The soft gel can be pushed out the opening at the second end of the barrel in various ways. For example, a threaded twist mechanism can be attached to a threaded shaft that extends into the barrel. The threaded shaft can drive a plunger or other component such that when the threaded twist mechanism is turned by a user, the plunger can move in the barrel either towards the second end to push soft gel out of the barrel, or towards the soft brush at the first end to make room for additional soft gel. The soft gel can be stored in cartridges in the barrel to prevent drying.

During use, the end cap can be removed. The plunger can be pushed or twisted such that soft gel is ejected from the opening. The soft gel can be applied to a perforated or mesh surface of a wearable device to be cleaned. For example, the area to be cleaned can be blotted using the soft gel. That is, the soft gel can be applied to the area to be cleaned in a gentle vertical motion. The soft gel can be torn away from the cleaning pen as needed or when cleaning is done. The end cap can be replaced over the opening to store the soft gel for the next use. The used soft gel can be biodegradable and therefore can be composted. The brush can be used to loosen debris on the perforated or mesh surface. The brush can be swept laterally across the mesh surface. Pushing the brush into the mesh surface can be avoided to prevent debris from being ground into the mesh surface. Alternatively, the brush can be used before the soft gel in these and other embodiments of the present invention. Either or both acts can be repeated as necessary. Additional steps can be included. For example, a softening solution can be applied during an initial cleaning step. An overall cleaning with a cleaning cloth can be performed as part of the process, for example after the brush and the soft gel have been used.

Perforated or mesh and other surfaces on electronic devices can be cleaned using embodiments of the present invention. For example, surfaces on watches, audio devices, such as in-ear devices, on-ear headphones, over-the-ear headphones, eyewear, smart phones, augmented-reality devices, virtual-reality devices, and other devices, can be cleaned. Surfaces on other devices, such as laptops, tablets, remote controls, monitors, and other devices can also be cleaned using embodiments of the present invention. These devices can be collectively referred to here as wearable devices for simplicity.

Various embodiments of the present invention can incorporate one or more of these and the other features described herein. A better understanding of the nature and advantages of the present invention can be gained by reference to the following detailed description and the accompanying drawings.

### BRIEF DESCRIPTION OF THE DRAWINGS

FIG. 1 illustrates a wearable device having a mesh surface that can be cleaned with a cleaning kit or cleaning pen according to an embodiment of the present invention;

FIG. 2 illustrates a cleaning kit according to an embodiment of the present invention;

FIG. 3 is a flowchart of a method of using the cleaning kit of FIG. 2 according to an embodiment of the present invention;

FIG. 4 illustrates another cleaning kit according to an embodiment of the present invention; and

FIG. 5 is a flowchart of a method of using the cleaning kit of FIG. 4 according to an embodiment of the present invention.

### DESCRIPTION OF EXEMPLARY EMBODIMENTS

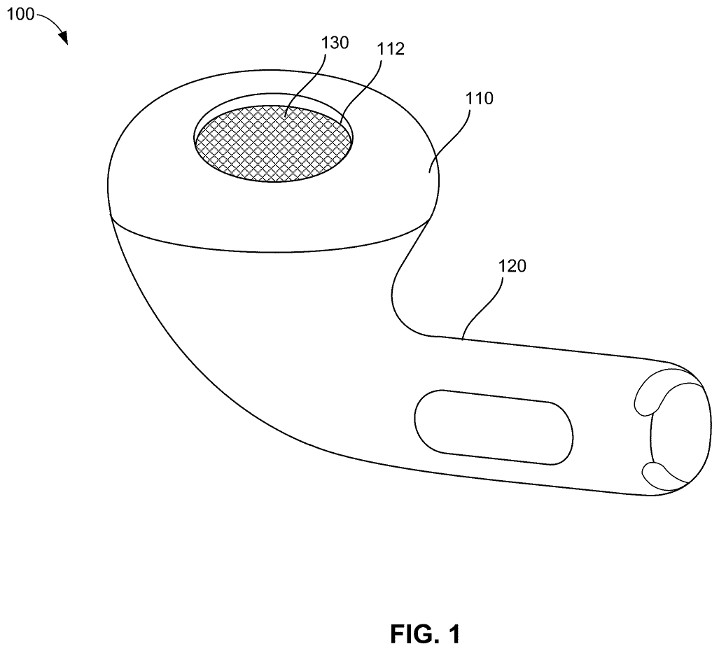

FIG. 1 illustrates a wearable device having a mesh surface that can be cleaned with a cleaning kit or cleaning pen according to an embodiment of the present invention. Wearable device 100 can be an earbud that can include ear-tip 110 and stem 120. Ear-tip 110 can be configured to be inserted in a user's ear canal. Stem 120 can be configured to extend from a user's ear. Ear-tip 110 can include opening 112. Opening 112 can surround mesh surface 130. A speaker (not shown) can provide audible signals to a user through mesh surface 130.

Since ear-tip 110 is positioned in a user's ear canal during operation, debris, such as ear wax, can build up on mesh surface 130. This debris can block audio waveforms from passing through mesh surface 130 to a user. Accordingly, embodiments of the present invention can provide kits, methods, and apparatus that can be used to clean mesh surface 130. Specifically, embodiments of the present invention can provide kits, methods, and apparatus for cleaning wearable devices that are simple to use, are less likely to cause damage, and are effective.

While wearable device 100 is shown in this example as an earbud or in-ear device, in these and other embodiments of the present invention, surfaces on other types of wearable devices can be cleaned, such as watches, on-ear headphones, over-the-ear headphones, eyewear, smart phones, augmented-reality devices, virtual-reality devices, and other devices. Other devices, such as laptops, tablets, remote controls, monitors, and other devices can also be cleaned using embodiments of the present invention. These devices can be collectively referred to here as wearable devices for simplicity.

While wearable device 100 is shown as having a mesh surface 130, other types of surfaces can be cleaned by embodiments of the present invention. For example, a surface can include a number of holes or micro-perforations. The surface can be formed of or include fabric, plastic, metal, or a combination of these and other materials. Mesh surface 130 can be formed of interlocking strips or wires of wires or plastic. While mesh surface 130 is included in wearable device 100 to provide an audio path, mesh surfaces can be provided on other wearable devices for other reasons, such as ventilation to allow for the cooling of components below or behind the surface. Such a surface can be provided to allow audio signals to be received, for example, a microphone can be located behind a perforated or mesh surface. Pressure stabilization or equalization can be provided by a perforated or mesh surface. For example, a barometer housed in a device can be near a perforated or mesh surface.

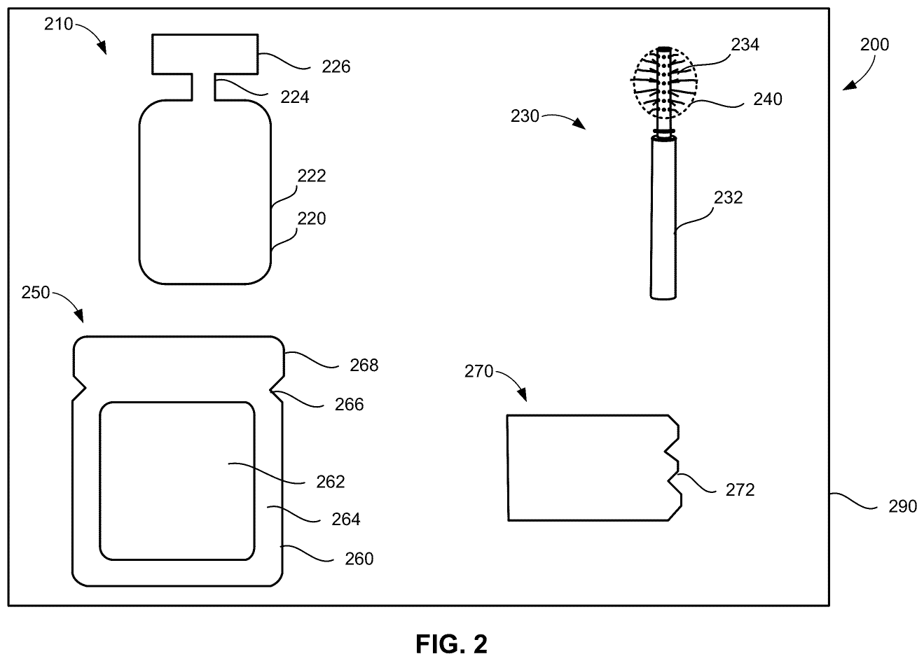

FIG. 2 illustrates a cleaning kit according to an embodiment of the present invention. Cleaning kit 200 can include components that can be effectively used in combination to clean a mesh or other surface of wearable device 100 (shown in FIG. 1.) Cleaning kit 200 can also be less likely to damage wearable device 100 as compared to conventional solutions.

Cleaning kit 200 can include softening solution 210. Softening solution 210 can be packaged in ampule 220. Ampule 220 can include body 222 that can contain softening solution 210. Ampule 220 can include tab 226 connected to body 222 through neck 224. Tab 226 can be twisted and removed to provide access to softening solution 210 stored in ampule 220. Softening solution 210 can be packaged for a one-time use. This can help keep softening solution 210 sterile before use to prevent degradation of effectiveness. Softening solution 210 can be packaged in a resealable container, or softening solution 210 can be packaged in another type of container. For example, softening solution 210 can be provided in a vial or other resealable container.

Ampule 220 can be plastic, glass, or other material. When plastic is used, ampule 220 can be squeezed to expel softening solution 210. Drops of softening solution 210 can be applied to mesh surface 130 (shown in FIG. 1) of wearable device 100 to at least partially dissolve debris. For example, wearable device 100 can be held such that mesh surface 130 is facing upwards. One, two, three, four, or more than four drops of softening solution 210 can be applied to mesh surface 130.

Softening solution 210 can be applied to mesh surface 130 without damaging underlying components (not shown) of wearable device 100. Specifically, softening solution 210 can have a high enough viscosity that it does not leach through mesh surface 130 or other protective layers (not shown) that can be below or behind mesh surface 130. That is, softening solution 210 can have a low capillary action such that it does not pass through mesh surface 130 or other protective layers, thereby helping to prevent damage to components in wearable device 100. This is in stark contrast to other solutions, such as isopropyl alcohol, which can have a lower viscosity allowing it to reach internal components (not shown) in wearable device 100. This can degrade performance after the isopropyl alcohol evaporates and leaves debris on the internal components, such as a speaker.

Excess softening solution 210 can be removed by gently tapping or shaking wearable device 100. That is, after time is provided for softening solution 210 to at least partially dissolve the debris, wearable device 100 can be turned such that mesh surface 130 faces downward. Wearable device 100 can be gently shaken with a vertical motion to remove excess softening solution 210.

Ear wax can be formed of a combination of proteins and oils. Accordingly, softening solution 210 can include a protein emulsifier to break up organic matter, such as ear wax, from mesh surface 130 of wearable device 100. The protein emulsifier can be a polycationic polymer, a poloxamine or poloxamer, a polysorbate, or other protein emulsifier. One or more thickening agents, preservatives, stabilizers, antibacterial agents, antifungals, sterilizing agents, water, salts, saline, sequestrants, or other substances can be included in various combinations in softening solution 210 consistent with embodiments of the present invention.

Cleaning kit 200 can further include brush 230. After softening solution 210 has softened debris on mesh surface 130, brush 230 can be used to break up and sweep debris aside. Brush 230 can be formed of a soft, non-metallic material. Brush 230 can be formed of an elastomer, such as silicone or other soft material. The material used to form brush 230 can have a Shore between 30 and 80. The material used to form brush 230 can have a Shore less than 80.

Brush 230 can have bristles 234 in a snowball pattern. That is, bristles 234 can have an outer reach 240 having a cross-section that is at least somewhat circular, or bristles 234 can have an outer reach 240 having a cross-section that is at least somewhat elliptical. That is, bristles 234 can have an outer reach 240 in a pattern that approximates a sphere, or bristles 234 can have an outer reach 240 in a pattern that approximates an ellipsoid. This snowball pattern can prevent brush 230 from being used to exert an excessive amount of force on mesh surface 130. Brush 230 can further include brush handle 232.

The snowball pattern of bristles 234 can have a surface area that is relatively large, the individual bristles 234 can be relatively thick, while brush handle 232 can be relatively short. This combination can allow mesh surface 130 to be cleaned with fewer strokes and less force, thereby providing further protection and helping to avoid puncturing or scratching mesh surface 130. For example, providing short handle 232 on brush 230 can reduce a length of a lever-arm through which force can be applied, thereby reducing the resulting force on mesh surface 130, while a large bristle 234 pattern can distribute the resulting force across a larger area of mesh surface 130. Bristles 234 on the brush 230 can be soft and thick such that debris is not pushed through a perforated or mesh surface 130 into wearable device 100. Where mesh surface 130 has a spacings such that bristles 234 can fit through mesh surface 130, the snowball pattern of bristles 234 can prevent excessive force from being applied to a structure (not shown) in wearable device 100 below mesh surface 130.

Brush 230 can be swept laterally across mesh surface 130 to effectively remove debris that has been softened by the softening solution 210. Vertical motion towards wearable device 100 can be avoided to prevent pushing debris further into mesh surface 130.

Various parameters of brush 230, such as the size of bristles 234, the size of the bristle 234 pattern, the length and thickness of handle 232, the stiffness of bristles 234, the stiffness of handle 232, and other parameters, can be varied to optimize cleaning of different wearable devices. The identity of a wearable device, the material that the surface to cleaned is made of, the presence or absence, and identity, of components below the surface to be cleaned, the size of the surface to be cleaned, and other factors, can be considered in determining these various parameters.

Cleaning kit 200 can further include soft gel 250. After brush 230 has swept softened debris away, soft gel 250 can be used to blot remaining debris. That is, soft gel 250 can adhere to remaining debris not swept away by brush 230. Soft gel 250 can be sealed in pouch 260 to help it retain its effectiveness. Pouch 260 can be formed of plastic, vinyl, foil, or other material or combination of materials. Pouch 260 can include sealing ring 264 formed by a sealing process around sealed region 262, which can contain the soft gel. Sealing ring 264 can be formed by stamping, heating, or a combination of these and other process steps. Pouch 260 can have tear notches 266 to allow for easy opening. Tear notches 266 can be used to separate tab portion 268 and allow access to soft gel 250 in sealed region 262.

Soft gel 250 can be a low-adhesion soft gel, though it can adhere well to organic substances, such as ear wax and other protein based substances generated by the user. Soft gel 250 can be soft enough to not provide excessive force when pushed against mesh surface 130 of wearable device 100. Soft gel 250 can have a low enough adhesion to not pull mesh surface 130 away from wearable device 100. That is, soft gel 250 can have a low enough adhesion to not pull mesh surface 130 away from an adhesive (not shown) securing mesh surface 130 in place in opening 112 of ear-tip 110 (both shown in FIG. 1) of wearable device 100. Soft gel 250 can also be viscous enough to prevent if from flowing into wearable device 100, which could otherwise cause damage. Soft gel 250 can be a hydrogel solution. Soft gel 250 can be water-based. Soft gel 250 can include aloe vera. One or more thickeners, stabilizers, preservatives, adhesives, softeners, antibacterial agents, antifungals, binding or linking agents—such as borax, coloring agents, aromatics, water, sterilizing agents, sequestrants, and or other substances can be included in soft gel 250 in various combinations consistent with embodiments of the present invention. Soft gel 250 can be biodegradable. Soft gel 250 can be blotted using a motion in a direction normal to mesh surface 130 of wearable device 100 to effectively pick up remaining debris.

The viscosity of soft gel 250 can be varied to optimize the cleaning of different wearable devices. The identity of a wearable device, the material that the surface to cleaned is made of, the presence or absence, and identity, of components below the surface to be cleaned, the size of the surface to be cleaned, and other factors, can be considered in determining the viscosity of soft gel 250. For some applications, viscosity can be increased, though soft gel 250 can retain a low-tack to hard surfaces to help to avoid damage. For other applications, viscosity can be decreased, thought soft gel 250 can retain enough viscosity, and a low enough capillary action, to prevent a flow into the wearable device.

Cleaning kit can include cleaning cloth 270. Cleaning cloth 270 can be included for a final clean-up of wearable device 100. Cleaning cloth can be a lint-free cloth to avoid leaving fibers in mesh surface 130 where they can work their way into wearable device 100. The lint-free cloth can be a microfiber or other cloth and can be formed of nylon, polyester, and polyamide, or a combination of these or other materials. Cleaning cloth 270 can complete the cleaning of wearable device 100 in an effective manner by not leaving lint or fibers. Cleaning cloth 270 can have textured, crenulated, or serrated edges 272.

Cleaning kit 200 can be provided in package 290. Package 290 can be formed of plastic, cardboard, or other material. Package 290 can be a plastic blister pack. Package 290 can be a folded cardboard package. The cardboard can be paperboard or other type of cardboard.

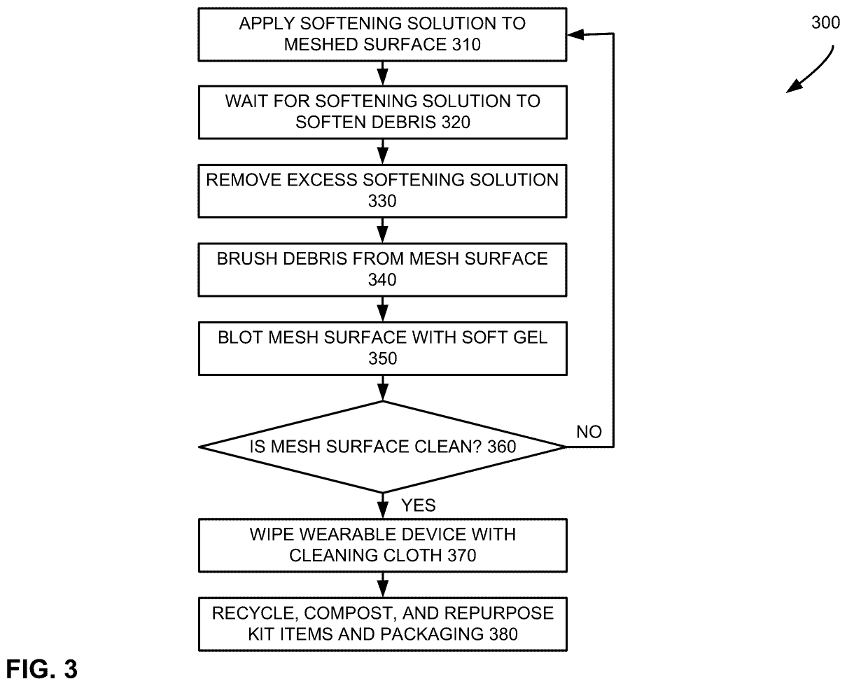

FIG. 3 is a flowchart of a method of using the cleaning kit of FIG. 2 according to an embodiment of the present invention. After package 290 is opened, in act 310, tab 226 can be twisted and separated from body 222 of ampule 220 at neck 224 (all shown in FIG. 2.) Ampule 220 can be held vertically over mesh surface 130 of wearable device 100 (both shown in FIG. 1.) Body 222 can be squeezed, thereby ejecting softening solution 210 (shown in FIG. 2) from body 222 through neck 224. For example, one, two, three, four, or more than four drops of softening solution 210 can be applied to mesh surface 130. Time can be given for the protein emulsifiers in softening solution 210 to work in act 320.

In act 330, excess softening solution 210 can be removed, for example by turning wearable device 100 such that mesh surface 130 faces downward, and then lightly shaking wearable device 100 in a vertical direction. Brush 230 (shown in FIG. 2) can be swept laterally across mesh surface 130 to remove the softened debris in act 340. Vertical motion or brush 230 towards wearable device 100 can be avoided to prevent pushing debris further into mesh surface 130.

In act 350, pouch 260 can be opened by grasping both sides of one of the tear notches 266 (both shown in FIG. 2) and pulling them apart. Soft gel 250 can be removed from sealed region 262 (both shown in FIG. 2.) Soft gel 250 can then be used to blot mesh surface 130 to further remove debris. That is, soft gel 250 can be applied to mesh surface 130 with gentle vertical pressure and then removed. This application step can be repeated as necessary.

In act 360, it can be determined whether mesh surface 130 is clean. If it is not, then act 310 through act 350 can be repeated. If mesh surface 130 is clean, then wearable device 100 can be cleaned with cleaning cloth 270 (shown in FIG. 2) in act 370. In act 380, package 290, ampule 220, brush 230, and pouch 260 can be recycled. Soft gel 250 can be biodegradable and can be composted. Cleaning cloth 270 can be repurposed to clean other objects. The acts shown here can be performed in a different order, one or more of these acts can be omitted, other acts can be included, or a combination of these can occur consistent with these and other embodiments of the present invention.

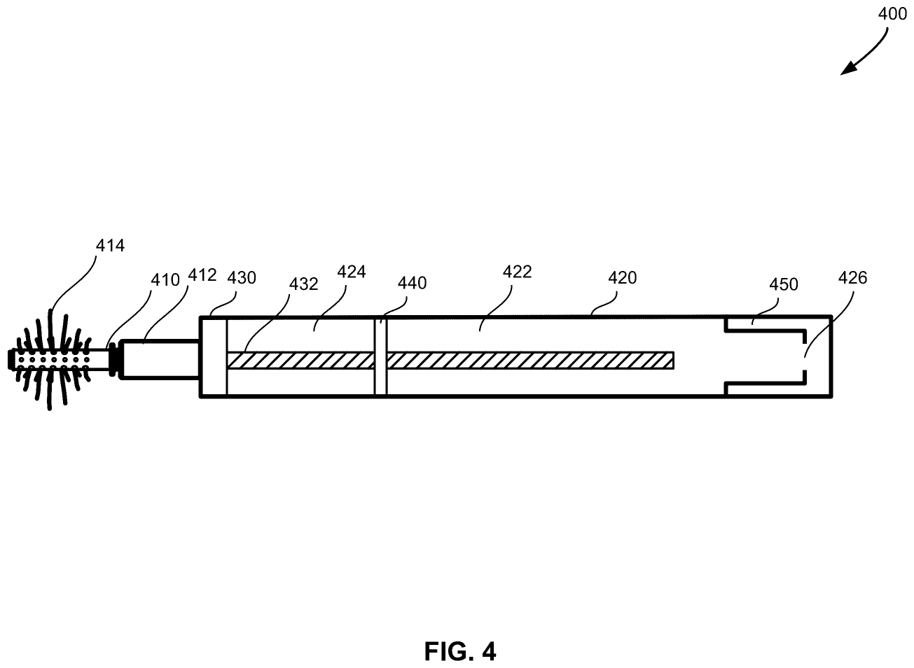

FIG. 4 is a cross-section of another cleaning kit according to an embodiment of the present invention. In this example, the cleaning kit can be a cleaning pen 400. Cleaning pen 400 can have a form factor that makes it easy to carry, since many users might already carry a pencil case for pencils to be used with tablet computing devices. Cleaning pen 400 can include brush portion 410. Brush portion 410 can include bristles 414 and shaft 412. Bristles 414 can be the same as or similar to bristles 234 (shown in FIG. 2.) Brush portion 410 can be the same as or similar to brush 230 (shown in FIG. 2.) Brush portion 410 can be attached or formed as part of twist mechanism 430. Twist mechanism 430 can have a circumferential groove (not shown) that accepts a circumferential tab (not shown) extending from an inside surface of barrel 420 to secure twist mechanism 430 to barrel 420. This arrangement can allow twist mechanism 430 to rotate around a main axis of barrel 420. Threaded shaft 432 can be attached to or formed as part of twist mechanism 430. Plunger 440 can be threaded to mate with threaded shaft 432. An outer surface of plunger 440 and an inside surface of barrel 420 can have keying features (not shown), such as raised longitudinal notches, to limit rotation of plunger 440 relative to barrel 420 when twist mechanism 430 is rotated. Barrel 420 can have opening 426 at an end opposite brush portion 410. End cap 450 can cover opening 426.

Barrel 420 can include a central cavity divided into chamber 422 and chamber 424 by plunger 440. Soft gel 250 (shown in FIG. 2) can be stored in chamber 422 of barrel 420. To use the soft gel 250, end cap 450 can be removed. As twist mechanism 430 is rotated, plunger 440 can move towards opening 426 in barrel 420, thereby ejecting soft gel 250 from barrel 420. This movement can reduce the size of chamber 422 and increase the size of chamber 424 in barrel 420. When sufficient soft gel 250 has been removed, end cap 450 can be replaced to prevent drying of soft gel 250. Soft gel 250 can be replaced, for example using cartridges (not shown) to prevent drying of soft gel 250.

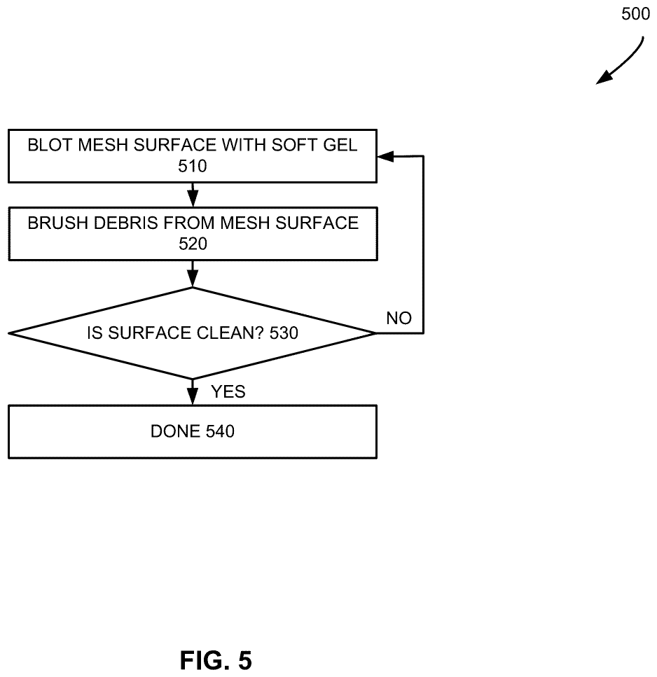

FIG. 5 is a flowchart of a method of using the cleaning kit of FIG. 4 according to an embodiment of the present invention. In act 510, end cap 450 can be removed from barrel 420 of cleaning pen 400 (both shown in FIG. 4.) Twist mechanism 430 can be twisted such that plunger 440 moves towards opening 426 (all shown in FIG. 4.) This movement can expel soft gel 250 (shown in FIG. 2) in chamber 422 (shown in FIG. 4) through opening 426. Soft gel 250 can be used to blot mesh surface 130 of wearable device 100 (both shown in FIG. 1) to remove debris. That is, soft gel 250 can be applied to mesh surface 130 with gentle vertical pressure and then removed. This application step can be repeated as necessary. Brush portion 410 (shown in FIG. 4) can be used to further remove debris from mesh surface 130. Alternatively, brush portion 410 can be used before soft gel 250. Brush portion 410 can be swept laterally across mesh surface 130 to remove the softened debris in act 520. Vertical motion towards wearable device 100 can be avoided to prevent pushing debris further into mesh surface 130. In act 530 it can be determined whether mesh surface 130 is clean. If it is, end cap 450 can be replaced and the process can cease in act 540. If mesh surface 130 is not clean, either or both of acts 510 and 520 can be repeated. The acts shown here can be performed in a different order, for example, mesh surface 130 can be brushed with brush portion 410 before soft gel 250 is used. One or more of these acts can be omitted, other acts can be included, or a combination of these can occur consistent with these and other embodiments of the present invention. Either or both the use of brush portion 410 and soft gel 250 can be repeated as necessary. Additional steps can be included. For example, softening solution 210 (shown in FIG. 2) can be applied during an initial cleaning step. An overall cleaning with cleaning cloth 270 (shown in FIG. 2) can be performed as part of the process, for example after the brush and the soft gel have been used.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A cleaning kit for wearable electronic devices, the cleaning kit comprising:
a package to enclose a plurality of cleaning utensils, the cleaning utensils comprising:
a cleaning cloth;
a softening solution;
a brush; and
a soft gel.

2. The cleaning kit of claim 1 wherein the softening solution is a protein emulsifier.

3. The cleaning kit of claim 2 wherein the soft gel is a biodegradable hydrogel.

4. The cleaning kit of claim 3 wherein the brush is formed of silicone and the cleaning cloth is a lint-free cloth.

5. The cleaning kit of claim 4 wherein the package is formed of folded cardboard.

6. The cleaning kit of claim 5 wherein the cardboard is paperboard.

7. The cleaning kit of claim 4 wherein the softening solution is sealed in a vial.

8. The cleaning kit of claim 4 wherein the softening solution is sealed in an ampule.

9. The cleaning kit of claim 8 wherein the soft gel is sealed in a pouch having a tear notch.

10. The cleaning kit of claim 9 wherein the brush has a Shore between 30 and 80.

11. A cleaning kit for wearable electronic devices, the cleaning kit comprising:
a package to enclose a plurality of cleaning utensils, the cleaning utensils comprising:
a cleaning cloth;
a softening solution sealed in an ampule;
a brush formed of an elastomer; and
a soft gel sealed in a packet.

12. The cleaning kit of claim 11 wherein the softening solution is a protein emulsifier.

13. The cleaning kit of claim 12 wherein the cleaning cloth is a microfiber cloth.

14. The cleaning kit of claim 13 wherein the soft gel is a biodegradable hydrogel and the packet is a pouch having a tear notch.

15. The cleaning kit of claim 14 wherein the brush comprises a plurality of bristles having a snowball pattern and the elastomer is silicone.

16. The cleaning kit of claim 15 wherein the brush has a Shore less than 80.

17. The cleaning kit of claim 15 wherein the brush has a Shore between 30 and 80.

18. A cleaning pen for wearable electronic devices, the cleaning pen comprising:
a barrel having a central cavity;
a brush at a first end of the barrel;
an end cap covering an opening at a second end of the barrel, the opening providing access to the central cavity, the second end opposite the first end; and
soft gel in the central cavity of the barrel.

19. The cleaning pen of claim 18 further comprising a plunger in the central cavity between the brush and the soft gel.

20. The cleaning pen of claim 19 wherein the plunger is configured engage with a threaded shaft, the threaded shaft attached to a twist mechanism that is configured to be rotated around the central axis of the barrel such that the plunger travels towards the second end of the barrel thereby ejecting the soft gel.
